(19) United States
(12) Patent Application Publication
(10) Pub. No.: US 2015/0145585 A1
(43) Pub. Date: May 28, 2015

(54) Sample Rate Converter and Rate Estimator Thereof and Rate Estimation Method Thereof

(71) Applicants: Kuo-Shih Tsai, HsinChu (TW); Tsung-Nan Wu, Zhubei City (TW)

(72) Inventors: Kuo-Shih Tsai, HsinChu (TW); Tsung-Nan Wu, Zhubei City (TW)

(73) Assignee: RICHTEK TECHNOLOGY CORPORATION, Zhubei City (TW)

(21) Appl. No.: 14/498,604

(22) Filed: Sep. 26, 2014

(30) Foreign Application Priority Data
Nov. 26, 2013 (TW) 102142919

(51) Int. Cl. G06G 7/04; G06G 7/30; G06G 7/18

(52) U.S. Cl. CPC G06G 7/04; G06G 7/1806; G06G 7/30
USPC 327/341

(57) ABSTRACT

A sample rate converter receives an input signal with an input sample rate, and generates an output signal with an output sample rate. The sample rate converter includes: a rate estimator, a polynomial interpolation calculation circuit, an up sampling filter, and a down sampling filter. The rate estimator includes: a subtractor, which generates an error signal according to an input clock signal and a second order rate signal; a first order integrator, which generates a first order rate signal according to the error signal; and a second order integrator, which generates the second order rate signal according to the first order rate signal.

### CROSS REFERENCE

The present invention claims priority to TW 102142919, filed on Nov. 26, 2013.

### BACKGROUND OF THE INVENTION

1. Field of Invention

The present invention relates to a sample rate converter and a rate estimator thereof and a rate estimation method thereof; particularly, it relates to such sample rate converter, rate estimator and rate estimation method wherein a buffer for storing conversion data is not required.

2. Description of Related Art

In general, a sample rate converter is for converting a digital signal with a sample rate to another digital signal with a different sample rate. For example, a signal stored in a compact disc (CD) can be read with a sample rate of 44.1 kHz (so the signal is stored in a CD format); and another signal stored in a digital audio tape (DAT) can be read with a sample rate 48 kHz (so the signal is stored in a DAT format). If an audio signal stored in a CD is to be stored in a DAT, the audio signal with the CD format requires to be converted to the audio signal with the DAT format, otherwise the audio signal can not be heard properly.

A typical sample rate converter is an asynchronous sample rate converter (ASRC). The ASRC converts an input signal with an input sample rate to a conversion data with a relatively higher sample rate by interpolation, and stores the conversion data in a buffer. The conversion data is read from the buffer as an output signal with an output sample rate; as such, the input signal with the input sample rate is converted to the output signal with the output sample rate.

FIG. 1 schematically shows a conversion method of the sample rate converter. In FIG. 1, solid arrows indicate the input signal with the input sample rate, and dashed arrows indicate the output signal with the output sample rate; besides, the horizontal axis indicates time and the vertical axis indicates amplitude. A polynomial interpolation calculation circuit converts the input signal to the conversion data with relatively more samples by interpolation, and stores the conversion data in the buffer. And the output signal with the output sample rate as indicated by the dashed arrows is generated according to a rate signal and the conversion data. Within a limited bandwidth, the original signal can be restored from the conversion data. The conversion data is thus converted to the output signal with the target output sample rate, which is different from the input sample rate, by the interpolation according to a ratio of the input sample rate to the output sample rate.

U.S. Pat. No. 7,948,405 discloses a sample rate converter including a buffer as indicated in FIG. 2, which converts the input signal to the conversion data by interpolation, and stores the conversion data in the buffer by an input signal index according to the input sample rate. The conversion data is converted to the output signal by an output signal index according to the output sample rate.

However, the aforementioned ASRC requires a buffer with a large capacity to store the conversion data, in order to prevent the output signal index from exceeding the input signal index, which may double generate the output signal or erase the unread conversion data.

In view of above, the present invention proposes a sample rate converter, a rate estimator thereof and a rate estimation method thereof, which do not require a buffer to thereby reduce the manufacturing cost and increase the conversion efficiency.

### SUMMARY OF THE INVENTION

From one perspective, the present invention provides a sample rate converter for receiving an input signal with an input sample rate and generating an output signal with an output sample rate, the sample rate converter including: a rate estimator, for receiving an input clock signal and an output clock signal, and generating a rate signal, wherein the input clock signal corresponds to the input sample rate and the output clock signal corresponds to the output sample rate, and the rate signal is related to the input sample rate and the output sample rate; a polynomial interpolation calculation circuit, which is coupled to the rate estimator, for generating a polynomial interpolation signal according to a conversion data signal and the rate signal; an up sampling filter, which is coupled to the polynomial interpolation calculation circuit, for generating the conversion data signal according to the input signal; and a down sampling filter, which is coupled to the polynomial interpolation calculation circuit, for generating the output signal according to the polynomial interpolation signal; wherein the rate estimator includes: a substractor, for generating an error signal according to the input clock signal and a second order rate signal; a first order integrator, which is coupled to the subtractor, for generating a first order rate signal according to the error signal; and a second order integrator, which is coupled to the first order integrator, for generating the second order rate signal according to the first order rate signal.

From another perspective, the present invention provides a rate estimator of a sample rate converter, wherein the sample rate converter is for receiving an input signal with an input sample rate and generating an output signal with an output sample rate, and the rate estimator is for receiving an input clock signal and an output clock signal, and generating a rate signal, wherein the input clock signal corresponds to the input sample rate and the output clock signal corresponds to the output sample rate, and the rate signal is related to the input sample rate and the output sample rate, the rate estimator including: a substractor, for generating an error signal according to the input clock signal and a second order rate signal; a first order integrator, which is coupled to the subtractor, for generating a first order rate signal according to the error signal; and a second order integrator, which is coupled to the first order integrator, for generating the second order rate signal according to the first order rate signal.

In one preferable embodiment, the rate estimator further includes an input integrator, which is coupled to the subtractor, for receiving the input clock signal to generate a normalization signal which is inputted to the subtractor.

In one preferable embodiment, the rate estimator further includes an interception circuit, which is coupled to the subtractor, for receiving the second order rate signal to generate the rate signal.

In the aforementioned embodiment, the first order integrator preferably converts the error signal to the first order rate signal according to an equation listed below:

$$Ti = [ {K}_{P} + \frac{{K}_{I}}{1 - {z}^{- 1}} ] ( 1 - Σ T )$$

wherein Ti is the first order rate signal, Kp is a ratio gain, KI is an integration gain, z is a z-transformation constant, 1−ΣT is the error signal, and ΣT is the second order rate signal.

In the aforementioned embodiment, the second order integrator preferably converts the first order rate signal to the second order rate signal according to an equation listed below:

$$Σ T = Ti \times \frac{1}{1 - {z}^{- 1}}$$

wherein Ti is the first order rate signal, z is a z-transformation constant, and ΣT is the second order rate signal.

In one preferable embodiment, the first order integrator includes: a first multiplier, which is coupled to the subtractor, for multiplying the error signal with a ratio gain to generate a ratio rate signal; a second multiplier, which is coupled to the subtractor, for multiplying the error signal with an integration gain to generate an integration rate signal; an adder, which is coupled to the first multiplier, for generating the first order rate signal according to the ratio rate signal and the integration rate signal; and a switch, which is coupled to the second order integrator, for determining whether or not to deliver the first order rate signal to the first order integrator according a switch control signal.

From another perspective, the present invention provides a rate estimation method of a rate estimator of a sample rate converter, wherein the sample rate converter is for receiving an input signal with an input sample rate and generating an output signal with an output sample rate, and the rate estimator is for receiving an input clock signal and an output clock signal, and generating a rate signal, wherein the input clock signal corresponds to the input sample rate and the output clock signal corresponds to the output sample rate, and the rate signal is related to the input sample rate and the output sample rate, the rate estimation method including: generating an error signal according to the input clock signal and a second order rate signal; generating a first order rate signal according to the error signal; and generating the second order rate signal according to the first order rate signal.

In one preferable embodiment, the step of generating the error signal according to the input clock signal and the second order rate signal further includes: generating a normalization signal according to the input clock signal.

In one preferable embodiment, the rate estimation method further includes: generating the rate signal according to the second order rate signal.

In the aforementioned embodiment, the step of generating the first order rate signal according to the error signal preferably converts the error signal to the first order rate signal according to an equation listed below:

$$Ti = [ {K}_{P} + \frac{{K}_{I}}{1 - {z}^{- 1}} ] ( 1 - Σ T )$$

wherein Ti is the first order rate signal, Kp is a ratio gain, KI is an integration gain, z is a z-transformation constant, 1−ΣT is the error signal, and ΣT is the second order rate signal.

In the aforementioned embodiment, the step of generating the second order rate signal according to the first order rate signal preferably converts the first order rate signal to the second order rate signal according to an equation listed below:

$$Σ T = Ti \times \frac{1}{1 - {z}^{- 1}}$$

wherein Ti is the first order rate signal, z is a z-transformation constant, and ΣT is the second order rate signal.

In one preferable embodiment, the step of generating the error signal according to the input clock signal and the second order rate signal includes: multiplying the error signal with a ratio gain to generate a ratio rate signal; multiplying the error signal with an integration gain to generate an integration rate signal; generating the first order rate signal according to the ratio rate signal and the integration rate signal; and determining whether or not to deliver the first order rate signal to the first order integrator according a switch control signal.

The objectives, technical details, features, and effects of the present invention will be better understood with regard to the detailed description of the embodiments below.

### BRIEF DESCRIPTION OF THE DRAWINGS

FIG. 1 shows a conversion method of the sample rate converter.

FIG. 2 shows a prior art buffer and how it operates.

FIGS. 3 and 4 show a first embodiment of the present invention.

FIG. 5 shows a second embodiment of the present invention.

FIG. 6 shows a third embodiment of the present invention.

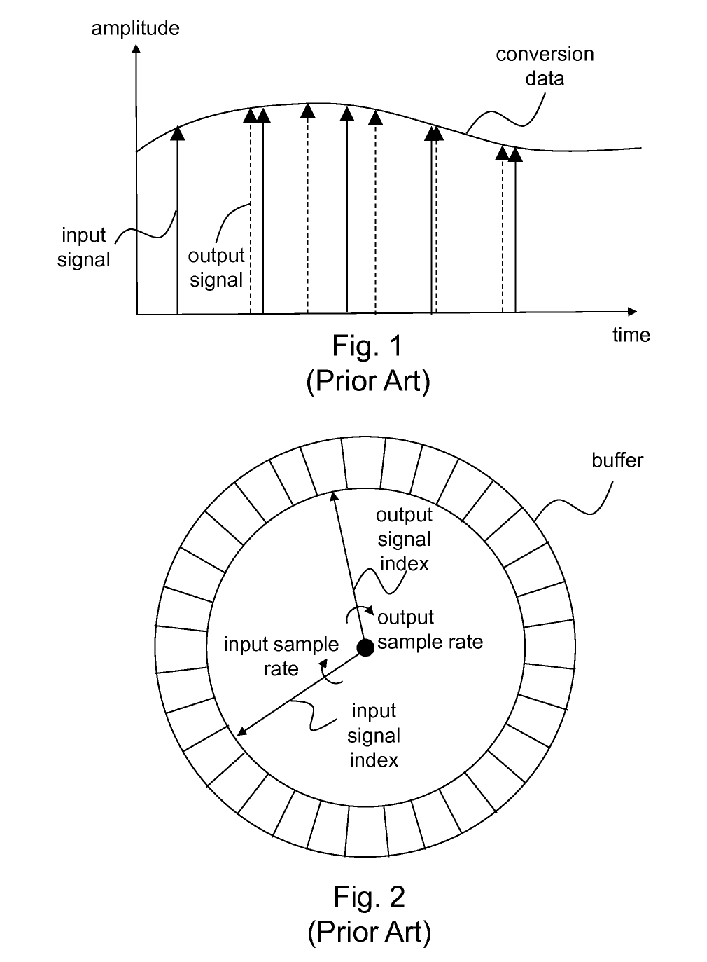

### DESCRIPTION OF THE PREFERRED EMBODIMENTS

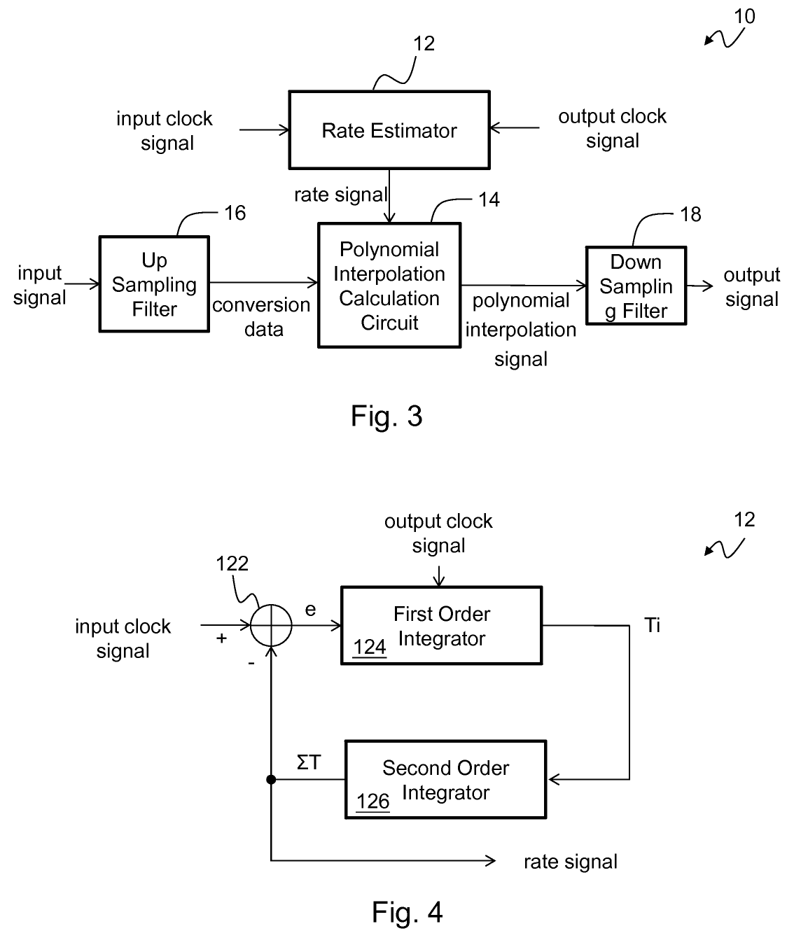

Please refer to FIGS. 3 and 4 for a first embodiment according to the present invention. A sample rate converter 10 is shown in FIG. 3, which is for receiving an input signal with an input sample rate, and generating an output signal with an output sample rate. In this embodiment, the sample rate converter 10 includes a rate estimator 12, a polynomial interpolation calculation circuit 14, an up sampling filter 16, and a down sampling filter 18. The rate estimator 12 is for receiving an input clock signal and an output clock signal, and generating a rate signal. The input clock signal corresponds to the input sample rate, and the output clock signal corresponds to the output sample rate. The rate signal is related to the input sample rate and the output sample rate; the rate signal can be, for example but not limited to, a ratio between the input sample rate and the output sample rate. The up sampling filter 16 receives the input signal with the input sample rate, and it increases the sample rate of the input signal to generate a conversion data, which is inputted to the polynomial interpolation calculation circuit 14. The polynomial interpolation calculation circuit 14 performs an interpolation operation on the conversion data signal according to the rate signal to generate a polynomial interpolation signal. The down sampling filter 18 is for generating the output signal with the output sample rate according to the polynomial interpolation signal.

FIG. 4 shows a schematic diagram of the rate estimator 12. As shown in FIG. 4, the rate estimator 12 includes: a subtractor 122, a first order integrator 124, and a second order integrator 126. The subtractor 122 is for generating an error signal e according to the input clock signal and a second order rate signal ΣT. For example, the subtractor 122 subtracts the second order rate signal ΣT from the input clock

$$Ti = {K}_{P} + \frac{{K}_{I}}{1 - {z}^{- 1}} ( 1 - Σ T )$$

signal which has been normalized to generate the error signal e. The first order integrator 124 generates a first order rate signal Ti according to the error signal e. The first order integrator 124 converts the error signal e to the first order rate signal Ti according to for example but not limited to an equation listed below:
wherein Kp is a ratio gain, KI is an integration gain, z is a z-transformation constant, 1−ΣT is the error signal, and ΣT is the second order rate signal.

The second order integrator 126 converts the first order rate signal Ti to the second order rate signal ΣT according to for example but not limited to an equation listed below:

$$Σ T = Ti \times \frac{1}{1 - {z}^{- 1}}$$

wherein the output clock signal is inputted to for example but not limited to the first order integrator 124 or the second order integrator 126.

This embodiment is different from the prior art in that, this embodiment includes two orders of integrator loops (including the first order integrator and the second order integrator), whereby the error signal e is converged to zero in a stabilized state. Therefore, the rate signal can be kept in the first order integrator or the second order integrator, and a large capacity buffer for storing the conversion data is not required.

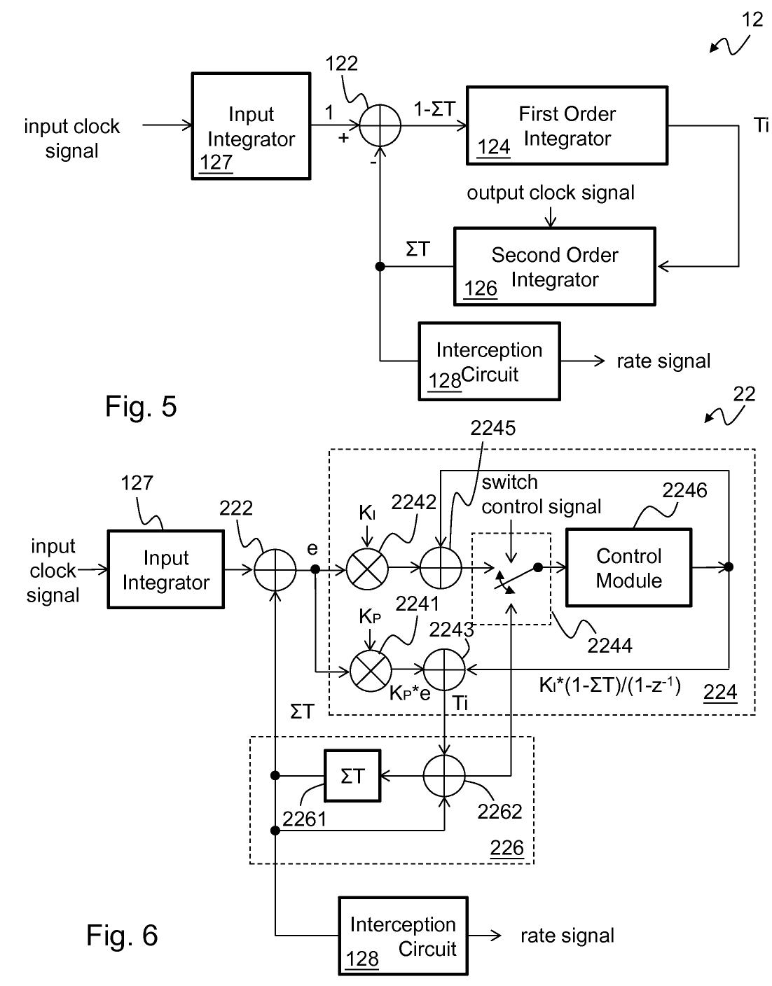

Please refer to FIG. 5 for a second embodiment according to the present invention. This embodiment is different from the first embodiment in that, in this embodiment, the estimator 12 further includes an input integrator 127 and an interception circuit 128. The input integrator 127 receives the input clock signal and generates a normalization signal which is inputted to the subtractor 122. Note that the normalization signal indicates a unity signal which has a value “1” for the subtractor 122. Therefore, the error signal e is 1−ΣT in the aforementioned equation. The interception circuit 128 is for receiving the second order rate signal ΣT to generate the rate signal. The interception circuit 128 for example performs an operation which omits an integer part of the second order rate signal ΣT, and leaves a fractional part of the second order rate signal ΣT, such that the rate signal has a value which is less than 1. Therefore, the polynomial interpolation calculation circuit 14 can directly perform the interpolation on the conversion data according to the rate signal to generate the output signal with the output sample rate without requiring a buffer, and the problems of double generating the output signal and erasing the unread conversion data will not occur. Note that it is not necessary for the rate estimator 12 to include both the input integrator 127 and the interception circuit 128; in another embodiment, the rate estimator 12 can include only one of them but not both.

Please refer to FIG. 6 for a third embodiment according to the present invention. In the embodiment shown in FIG. 6, the rate estimator 22 includes: a subtractor 222, a first order integrator 224, a second order integrator 226, an input integrator 127, and an interception circuit 128. The first order integrator 224 includes: a multiplier 2241, a multiplier 2242, an adder 2243, a switch 2244, an adder 2245, and a control module 2246. During normal operation, a switch control signal controls the switch 2244 to couple the multiplier 2242 to the control module 2246 via the adder 2245. The multiplier 2241 is coupled to the subtractor 222, for multiplying the error signal e with a ratio gain Kp to generate a ratio rate signal Kp*e. The multiplier 2242 is coupled to the subtractor 222, for multiplying the error signal e with an integration gain KI to generate an integration rate signal KI*(1−ΣT)/(1−z−1) via a control loop including the control module 2246. The adder 2243 is coupled to the multiplier 2241 and the control module 2246, for generating the first order rate signal Ti by adding the ratio rate signal KP*e with the integration rate signal KI*(1−ΣT)/(1−z−1). The control loops operate as thus. For example, when the rate signal is required to approach a target rate signal in a stable state of the control system, the ratio gain Kp and the integration gain KI can be modified, for example the ratio gain Kp and the integration gain KI can be decreased, to set the target rate signal. Accordingly, the switch control signal controls the switch 2244 to couple the control module 2246 to the second order integrator 226, such that the first order rate signal Ti is fed back to the control module 2246 of the first order integrator 224, as an initial value of the control module 2246 after the ratio gain Kp and the integration gain KI have been decreased (or changed). In this embodiment, the second order integrator 226 includes a control module 2261 and an adder 2262, and the second order integrator 226 converts the first order rate signal Ti to the second order rate signal ΣT according to an equation listed below:

$$Σ T = Ti \times \frac{1}{1 - {z}^{- 1}}$$

wherein the interception circuit 128 performs an operation to omit an integer part of the second order rate signal ΣT, and leave a fractional part of the second order rate signal ΣT, such that the rate signal has a value which is less than 1.

By control system theory, any control loop with an order higher than two can converge the error signal e to zero, and therefore the input integrator 127 is not absolutely required but can be omitted. However, the input integrator 127 is preferable because it can speed up the convergence of the error signal e. Because the rate signal (such as the second order rate signal ΣT) requires only a very small memory capacity to store, a buffer is not required and for example, the rate signal can be stored in the integrator. Further, because the error signal e will be converged to zero, signals which need to be operated according to the present invention are not limited by the bandwidth of the system. The above advantages show that the present invention is superior to the prior art.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits shown to be in direct connection in the embodiments, such as a switch or the like, so the term “couple” should include direct and indirect connections. In view of the foregoing, the spirit of the present invention should cover all such and other modifications and variations, which should be interpreted to fall within the scope of the following claims and their equivalents.

What is claimed is:

1. A sample rate converter for receiving an input signal with an input sample rate and generating an output signal with an output sample rate, the sample rate converter comprising:
a rate estimator, for receiving an input clock signal and an output clock signal, and generating a rate signal, wherein the input clock signal corresponds the input sample rate and the output clock signal corresponds to the output sample rate, and wherein the rate signal is related to the input sample rate and the output sample rate;
a polynomial interpolation calculation circuit, which is coupled to the rate estimator, for generating a polynomial interpolation signal according to a conversion data signal and the rate signal;
an up sampling filter, which is coupled to the polynomial interpolation calculation circuit, for generating the conversion data signal according to the input signal; and
a down sampling filter, which is coupled to the polynomial interpolation calculation circuit, for generating the output signal according to the polynomial interpolation signal;
wherein the rate estimator includes:
a subtractor, for generating an error signal according to the input clock signal and a second order rate signal;
a first order integrator, which is coupled to the subtractor, for generating a first order rate signal according to the error signal; and
a second order integrator, which is coupled to the first order integrator, for generating the second order rate signal according to the first order rate signal.

2. The sample rate converter of claim 1, wherein the rate estimator further includes an input integrator, which is coupled to the subtractor, for receiving the input clock signal to generate a normalization signal which is inputted to the subtractor.

3. The sample rate converter of claim 1, wherein the rate estimator further includes an interception circuit, which is coupled to the subtractor, for receiving the second order rate signal to generate the rate signal.

4. The sample rate converter of claim 2, wherein the first order integrator converts the error signal to the first order rate signal according to an equation listed below:
$$Ti = [ {K}_{P} + \frac{{K}_{I}}{1 - {z}^{- 1}} ] ( 1 - Σ T )$$
wherein Ti is the first order rate signal, Kp is a ratio gain, KI is an integration gain, z is a z-transformation constant, 1−ΣT is the error signal, and ΣT is the second order rate signal.

5. The sample rate converter of claim 2, wherein the second order integrator converts the first order rate signal to the second order rate signal according to an equation listed below:
$$Σ T = Ti \times \frac{1}{1 - {z}^{- 1}}$$
wherein Ti is the first order rate signal, z is a z-transformation constant, and ΣT is the second order rate signal.

6. The sample rate converter of claim 1, wherein the first order integrator includes:
a first multiplier, which is coupled to the subtractor, for multiplying the error signal with a ratio gain to generate a ratio rate signal;
a second multiplier, which is coupled to the subtractor, for multiplying the error signal with an integration gain to generate an integration rate signal;
an adder, which is coupled to the first multiplier, for generating the first order rate signal according to the ratio rate signal and the integration rate signal; and
a switch, which is coupled to the second order integrator, for determining whether or not to deliver the first order rate signal to the first order integrator according a switch control signal.

7. A rate estimator of a sample rate converter, wherein the sample rate converter is for receiving an input signal with an input sample rate and generating an output signal with an output sample rate, and the rate estimator is for receiving an input clock signal and an output clock signal, and generating a rate signal, wherein the input clock signal corresponds to the input sample rate and the output clock signal corresponds to the output sample rate, and the rate signal is related to the input sample rate and the output sample rate, the rate estimator comprising:
a substractor, for generating an error signal according to the input clock signal and a second order rate signal;
a first order integrator, which is coupled to the subtractor, for generating a first order rate signal according to the error signal; and
a second order integrator, which is coupled to the first order integrator, for generating the second order rate signal according to the first order rate signal.

8. The rate estimator of claim 7, further comprising an input integrator, which is coupled to the subtractor, for receiving the input clock signal to generate a normalization signal which is inputted to the subtractor.

9. The rate estimator of claim 7, wherein the rate estimator further includes an interception circuit, which is coupled to the subtractor, for receiving the second order rate signal to generate the rate signal.

10. The rate estimator of claim 8, wherein the first order integrator converts the error signal to the first order rate signal according to an equation listed below:
$$Ti = [ {K}_{P} + \frac{{K}_{I}}{1 - {z}^{- 1}} ] ( 1 - Σ T )$$
wherein Ti is the first order rate signal, Kp is a ratio gain, KI is an integration gain, z is a z-transformation constant, 1−ΣT is the error signal, and ΣT is the second order rate signal.

11. The rate estimator of claim 8, wherein the second order integrator converts the first order rate signal to the second order rate signal according to an equation listed below:
$$Σ T = Ti \times \frac{1}{1 - {z}^{- 1}}$$
wherein Ti is the first order rate signal, z is a z-transformation constant, and ΣT is the second order rate signal.

12. The rate estimator of claim 7, wherein the first order integrator includes:
a first multiplier, which is coupled to the subtractor, for multiplying the error signal with a ratio gain to generate a ratio rate signal;
a second multiplier, which is coupled to the subtractor, for multiplying the error signal with an integration gain to generate an integration rate signal;
an adder, which is coupled to the first multiplier, for generating the first order rate signal according to the ratio rate signal and the integration rate signal; and
a switch, which is coupled to the second order integrator, for determining whether or not to deliver the first order rate signal to the first order integrator according a switch control signal.

13. A rate estimation method of a rate estimator of a sample rate converter, wherein the sample rate converter is for receiving an input signal with an input sample rate, and generating an output signal with an output sample rate, and the rate estimator is for receiving an input clock signal and an output clock signal, and generating a rate signal, wherein the input clock signal corresponds to the input sample rate and the output clock signal corresponds to the output sample rate, and the rate signal is related to the input sample rate and the output sample rate, the rate estimation method comprising:
generating an error signal according to the input clock signal and a second order rate signal;
generating a first order rate signal according to the error signal; and
generating the second order rate signal according to the first order rate signal.

14. The rate estimation method of claim 13, wherein the step of generating the error signal according to the input clock signal and the second order rate signal further includes: generating a normalization signal according to the input clock signal.

15. The rate estimation method of claim 13, further comprising: generating the rate signal according to the second order rate signal.

16. The rate estimation method of claim 14, wherein the step of generating the first order rate signal according to the error signal converts the error signal to the first order rate signal according to an equation listed below:
$$Ti = [ {K}_{P} + \frac{{K}_{I}}{1 - {z}^{- 1}} ] ( 1 - Σ T )$$
wherein Ti is the first order rate signal, Kp is a ratio gain, KI is an integration gain, z is a z-transformation constant, 1−ΣT is the error signal, and ΣT is the second order rate signal.

17. The rate estimation method of claim 14, wherein the step of generating the second order rate signal according to the first order rate signal converts the first order rate signal to the second order rate signal according to an equation listed below:
$$Σ T = Ti \times \frac{1}{1 - {z}^{- 1}}$$
wherein Ti is the first order rate signal, z is a z-transformation constant, and ΣT is the second order rate signal.

18. The rate estimation method of claim 13, wherein the step of generating the error signal according to the input clock signal and the second order rate signal includes:
multiplying the error signal with a ratio gain to generate a ratio rate signal;
multiplying the error signal with an integration gain to generate an integration rate signal;
generating the first order rate signal according to the ratio rate signal and the integration rate signal; and
determining whether or not to deliver the first order rate signal to the first order integrator according a switch control signal.
